(19) United States
(12) Patent Application Publication
(10) Pub. No.: US 2026/0257838 A1
(43) Pub. Date: Sep. 3, 2026

(54) FIBER-BASED CONTAINERS COMPRISING A POLYMERIC COATING

(71) Applicant: THE PROCTER & GAMBLE COMPANY, Cincinnati, OH (US)

(72) Inventors: Els Julia Kristien LESAGE, leper (BE); Emily Charlotte BOSWELL, Wyoming, OH (US); Likith Gowda, Herlev (DK); Saeed Zajforoushan Moghaddam, Søborg (DK)

(21) Appl. No.: 19/539,928

(22) Filed: Feb. 13, 2026

Related U.S. Application Data
(60) Provisional application No. 63/758,412, filed on Feb. 14, 2025.

(51) Int. Cl. B65D 25/14; B65D 25/34; C09D 123/06

(52) U.S. Cl. CPC B65D 25/14; B65D 25/34; C09D 123/06

(57) ABSTRACT

Containers made with a fiber-based material layer and a polymeric coating disposed on at least some portions of the fiber-based material layer. The polymeric coating material(s) can have and/or exhibit preferred physical properties, melt flow properties, and/or end use benefit properties. For example, the containers comprising preferred polymeric coating materials have an Environmental Stress Crack Resistance sufficient to enable the containers to store liquid detergent compositions for multiple months with minimal to no leakage.

### FIELD

The present disclosure generally relates to containers comprising a fiber-based material layer and a polymeric coating. The containers can take many forms including bottles, cartons, trays, and the like, and can be used to store liquids, solids, and mixed compositions.

### BACKGROUND

The design and manufacture of paper and other fiber-based containers have greatly improved over the past few years. Paper containers typically comprise molded pulp as the base material and a polymeric barrier coating covering at least a portion of the fiber-based material. One technique for adding the polymeric barrier coating is by spraying a polymer powder onto the base fiber material and then subjecting the polymer powder to a heating step to cause the powder particles to coalesce into a more continuous material layer.

The environmental stress crack resistance of some historically used polymers can be insufficient for containers designed to store certain types of product compositions. For example, some laundry detergent compositions include non-ionic surfactants and various perfume raw materials which can break down or disentangle polymer chains creating weaknesses that can lead to stress cracks in the barrier coating. Furthermore, some historically used polymers struggle to fully coalesce in the heat treatment step resulting in pinholes through which a liquid composition can flow and ultimately leak from the container. Inadequate coalescing can also form defects in the barrier coating that act to concentrate stress leading to cracking. To compensate for poor coalescing, additional quantities of polymer can be added to better ensure the coating serves its barrier function. Increased polymer thickness, however, may be counter to some sustainability and recycling goals.

Therefore, there is a continuing need to provide a fiber-based container with improved polymeric barrier coating materials.

### SUMMARY

Containers comprising a body that includes a fiber-based material layer and a polymeric coating are provided. The polymeric coatings have good environmental stress crack resistance. Materials useful for the polymeric coating exhibit excellent melt flow properties, such as melt elasticity and melt flow index (MFI). At least some of the polymeric coating materials are softer than previously used materials and therefore can better deform and release stress when stress is applied to the containers. The polymeric coating materials can have specific values of molecular weight, molecular weight distribution, and comonomer type that enhance the resistance to stress crack resistance. And at least some of the polymeric coating materials can have relatively high crystallinity, which can result in better moisture resistance.

### BRIEF DESCRIPTION OF THE DRAWINGS

The above-mentioned and other features and advantages of the present disclosure, and the manner of attaining them, will become more apparent and the disclosure itself will be better understood by reference to the following description of example forms of the disclosure taken in conjunction with the accompanying drawings, wherein:

FIG. 1 is a perspective view of an exemplary container in the form of a bottle;

FIG. 2 is a partial cross-sectional view of the bottle shown in FIG. 1;

FIG. 3 is a perspective view of another exemplary container in the form of a tub;

FIGS. 4 and 5 are cross-sectional views of alternative forms of the container shown in FIG. 3;

FIG. 6 is a perspective view of the bottle shown in FIG. 1 with an optional closure cap secured thereto;

FIGS. 7 and 8 are partial cross-sectional views of alternative forms of the neck finish of the bottle shown in FIG. 1;

FIGS. 9 to 11 are Differential Scanning calorimetry curves generated from polymeric coating materials useful for the containers provided herein; and

FIGS. 12 to 14 are Scanning Electron Microscope images of polymeric coating surfaces from exemplary containers.

### DETAILED DESCRIPTION

Reference within the specification to “form(s)”, “aspect(s)”, “embodiment(s)” or the like means that a particular material, feature, structure and/or characteristic described in connection with the form/aspect/embodiment is included in at least one form/aspect/embodiment, optionally several forms/aspects/embodiments, but it does not mean that all forms/aspects/embodiments incorporate the material, feature, structure, and/or characteristic described. Furthermore, materials, features, structures and/or characteristics may be combined in any suitable manner across different forms/aspects/embodiments, and materials, features, structures and/or characteristics may be omitted or substituted from what is described. Thus, forms/aspects/embodiments described herein may comprise or be combinable with elements or components of other forms/aspects/embodiments despite not being expressly exemplified in combination, unless otherwise stated or an incompatibility is stated.

“Bottle” as used herein is broadly defined as a vessel to contain liquids, solids, or combinations thereof, and not limited to a particular geometry or size, or having specific features not called out the appended claims.

“Compressed pulp”, “molded pulp”, “fiber-based” are herein to be understood as a mixture of water, fibers (especially paper or wood fibers, potentially recycled material) and optionally a binding agent. The mixture is shaped, pressed and dried. While cellulosic pulp fibers are particularly suitable for the containers of the present invention, other fibers are contemplated.

“Fabric & Home Care” means compositions, products and methods for treating fabrics, hard surfaces, or any other surfaces, or relating to treating air; for personal, consumer, residential, commercial, or institutional use including: (a) fabric and laundry conditioning (including softening, freshening, wrinkle removal or prevention, stain prevention, or modification of properties of fabric or clothing), (b) fabric or laundry detergency (including, cleaning or stain removal), (c) laundry rinse additives or care, hard surface cleaning or treatment, (d) air care (including air freshening, purification, or malodor prevention, removal, or control), (e) car care (including air care, fabric care, or hard surface care in cars, trucks, or other vehicles), (f) dishwashing, (g) composting, and (h) other cleaning products and methods for residential, commercial, or institutional use.

“Layer” as used herein means a sheet, quantity, or thickness of material. The layer can be continuous, discontinuous, or even exist in a pattern. The layer need not be separable intact from an adjacent material, surface or body. For example, the layer may break or some materials from an adjacent material, surface, or body can at least partially stick to a layer upon its removal from the adjacent material, surface or body.

Every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

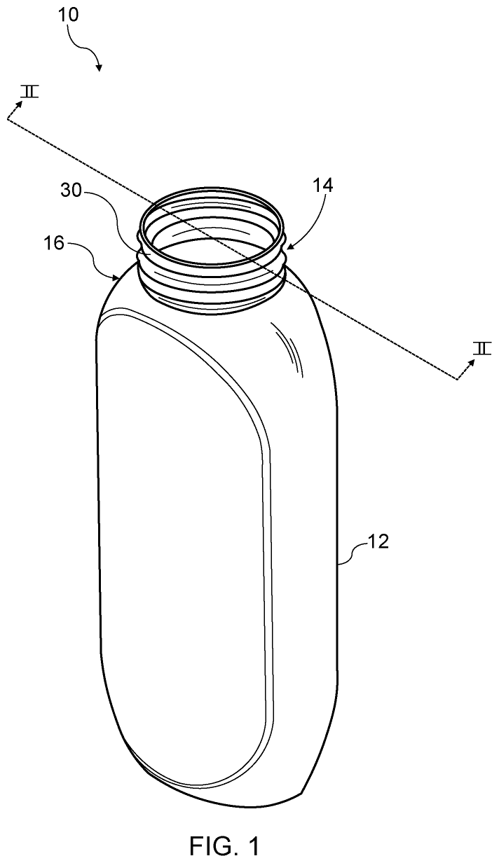

Containers provided herein comprise a body that includes a fiber-based material layer and a polymeric coating disposed on at least some portions of the fiber-based material layer. The containers can take various forms, including bottles, cartons, trays, and the like. An exemplary container in the form of a bottle is shown in FIG. 1. Bottle 10 includes a body 12, a neck 14, and a shoulder region 16 therebetween. While bottle 10 comprises a rectangular cross-section with outwardly bowed front and rear walls, other cross-sectional geometries are contemplated herein, including, but not limited to, circular, oval, or polygonal (e.g. rectangular, square, octagonal, etc.), or some combination thereof.

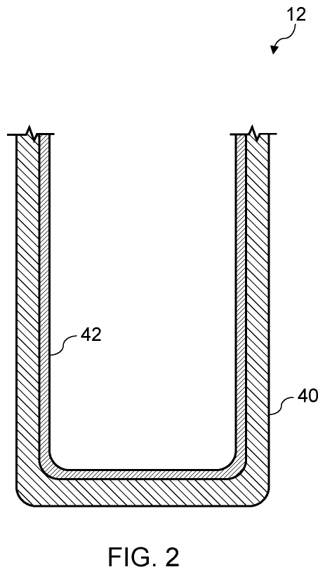

FIG. 2 is a partial cross-sectional view of body 12, taken through line II-II in FIG. 1. As illustrated, body 12 comprises a first layer 40 and a second layer 42. First layer 40 comprises a fiber-based material that can provide the overall stability of the container. First layer 40 can comprise a cellulosic fiber material such as compressed or molded pulp. A variety of different pulp fibers can be used. In one aspect, the pulp fibers are sourced from trees and can be softwood, hardwood, or a blend of the two. Virgin pulp fibers, recycled pulp fibers, and mixtures thereof are acceptable. In one embodiment, the fiber-based material layer can comprise post-consumer recycled fibers. The fiber-based material may comprise fibers alternative or in addition to pulp fibers; for example, regenerated cellulosic fibers (such as rayon, cellulose acetate, or lyocell fibers), polyvinyl alcohol fibers, polylactic acid fibers, starch fibers, and mixtures thereof.

An exemplary pulp fiber blend comprises a first pulp and a second pulp. The first pulp comprises 65-90% of a pulp having a Schopper-Riegler number according to ISO 5267-1 of below 48, and the second pulp comprises 10-35% of a pulp having a Schopper-Riegler number of 60-90. At least 50% of the first and second pulp blend comprises softwood pulp.

Second layer 42 comprises a polymeric coating that can serve as a barrier coating for the containers. Ideally, polymers and polymer blends for use in second layer 42 exhibit properties that can address at least one of several goals and objectives, including, for example, processability, barrier properties, and recyclability and/or compostability.

In one form, second layer 42 comprises low-density polyethylene (“LDPE”), such as Lucalen A2700M from LyondellBasell. In another form, second layer 42 comprises linear low-density polyethylene (“LLDPE”). Suitable and commercially available LLDPE materials include Lupolen 3621 M RM from LyondellBasell and EXCEED 0015XC from ExxonMobil. In some forms, the polymeric coating comprises greater than 50%, 60%, 70%, 80%, or 90% of LDPE and/or LLDPE.

The polymeric coating material may comprise other polymers and polymer blends, particularly when they have physical properties and/or provide performance parameters similar to those described herein. For example, the polymeric coating material may comprise a polymer blend that includes LDPE and LLDPE. In another example, the polymeric coating material may comprise a polymer blend that includes a first polymer that comprises at least one of LDPE and LLDPE, and a second polymer that is different from the first polymer. By way of example only, the second polymer can include polyolefins such as LDPE, LLDPE, very low-density polyethylene (“VLDPE”), medium-density polyethylene (“MDPE”), high-density polyethylene (“HDPE”), and ethylene vinyl acetate (“EVA”) and polypropylene (PP); and polyamides; acrylics, polyesters, and elastomers.

In addition to the use of homopolymer polyethylene, copolymers comprising polyethylene are particularly suitable for containers herein due to their higher resistance to stress cracking, lower glass transition temperature, and lower melting temperature. In addition, a homopolymer may be blended with a copolymer material. In some cases, comonomers used to make the copolymers can be hexene, butene, octene, butyl acrylate, and vinyl acetate.

The polyethylene can be produced using either a Ziegler-Natta catalyst or a metallocene catalyst.

The polymeric coating materials may be petroleum-based or bio-based. In one form, the polymeric material layer comprises a bio-based polymer (e.g., LDPE) content of at least 80% by weight, wherein the bio-based material is defined according to the standards ASTM D 6866, CEN/TS 16137 and ISO 16620. The bio-based polymer can include LDPE, HDPE, polyethylene terephthalate, polyethylene furanoate, and polyethylene isosorbide terephthalate.

The polymeric coating material may also comprise biodegradable materials, which can be bio-based, synthetic, or a blend thereof. Examples include, but are not limited to, poly lactic acid (“PLA”), polybutylene succinate (“PBS”), polybutylene succinate adipate (“PBSA”), polyhydroxyalkanoate (“PHA”), or polyhydroxybutyrate (“PHB”), 3-hydroxybutyrate-co-3-hydroxyvalerate (“PHBV”), poly(3-hydroxybutyrate-co-4-hydroxybutyrate (“P3HB4HB”), poly-3-hydroxybutyrate (“P3HB”), or blends thereof, and unmodified polysaccharides (e.g., cellulose). Synthetic biodegradable material can include polyvinyl alcohol (“PVA”), polybutyl adipate terephthalate (“PBAT”), poly-s-caprolactone (“PCL”), polyglycolide or poly(glycolic acid) (“PGA”), modified polysaccharides, and poly propylene carbonates (“PPC”), which are considered biodegradable according to at least the standard DIN EN 13432.

The polymeric coating material may have a post-consumer recycled content of at least 30% by weight.

The polymeric coating material may comprise additional materials, including, for example, antioxidants, processing aids, pigments, fillers, crystal nucleating agents, lubricants, plasticizers, anti-static agents, flame retardants, conductive additives, heat insulators, cross-linkers, ultraviolet absorbers, colorants, inorganic fillers, organic fillers, hydrolysis inhibitors, UV inhibitors, and the like.

Contemplated fillers include, but are not limited to, inorganic fillers such as, for example, the oxides of magnesium, aluminum, silicon, and titanium. These materials can be added as inexpensive fillers or processing aides. Other inorganic materials that can function as fillers include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, phosphate salts, can be used. Additionally, alkyd resins can also be added to the composition. Alkyd resins can comprise a polyol, a polyacid or anhydride, and/or a fatty acid.

Contemplated nanoparticles can be selected from the group including metals, metal oxides, allotropes of carbon, clays, organically modified clays, sulfates, nitrides, hydroxides, oxy/hydroxides, particulate water in-soluble polymers, silicates, phosphates and carbonates. Specific examples can include silicon dioxide, carbon black, graphite, grapheme, fullerenes, expanded graphite, carbon nanotubes, talc, calcium carbonate, bentonite, montmorillonite, kaolin, zinc glycerolate, silica, aluminosilicates, boron nitride, aluminum nitride, barium sulfate, calcium sulfate, antimony oxide, feldspar, mica, nickel, copper, iron, cobalt, steel, gold, silver, platinum, aluminum, wollastonite, aluminum oxide, zirconium oxide, titanium dioxide, cerium oxide, zinc oxide, magnesium oxide, tin oxide, iron oxides (Fe2O3, Fe3O4) and mixtures thereof. Nanoparticles can increase strength, thermal stability, and/or abrasion resistance of the polymeric coating composition disclosed herein and can give the compositions electric properties.

In particular aspects, the filler can comprise renewable fillers. These can include, but are not limited to, lipids (e.g., hydrogenated soybean oil, hydrogenated castor oil), cellulosics (e.g., cotton, wood, hemp, paperboard), lignin, bamboo, straw, grass, kenaf, cellulosic fiber, chitin, chitosan, flax, keratin, algae fillers, natural rubber, nanocrystalline starch, nanocrystalline cellulose, collagen, whey, gluten, and combinations thereof. Some of these types of additives may be biodegradable.

The optional additives may be present in an amount ranging from about 0.1 wt % to about 0.9 wt %, from about 1 wt % to about 40 wt %, from about 2 wt % to about 30 wt %, or from about 4 wt % to about 15 wt %, by weight of a polymeric coating composition.

Preferred polymeric coating materials can have and/or exhibit certain physical properties, melt flow properties, and/or end use benefit properties. For example, suitable polymeric coating materials can have a density of less than 0.94 g/cm³. Preferred LDPE's and LLDPE's have a molecular weight of from about 100,000 to about 250,000 g/mol and a molecular weight distribution of at least 2.5. Polymers with these properties can exhibit a Full Notch Creep Test value of greater than 5 hours, 10 hours, or 15 hours, and an Environmental Stress Crack Resistance F50 value of greater than 500 hours or 1,000 hours. It should be noted that minor component materials having a molecular weight in the range of 50,000 g/mol to 500,000 g/mol, for example, may be blended with the primary polymeric coating materials. It is believed that when polymer particles can melt at lower temperature and flow more easily at a given temperature (without resulting in burning of the fiber-based material underneath), that they will experience better coalescence with neighboring particles and result in a smoother coating. In some aspects, the polymeric coating materials can exhibit a melt flow rate of greater than 2.5 g/10 min, and a melt elasticity characterization of velocity at break of greater than 250 mm/sec. It is believed that the formation of smaller crystallites can also help to achieve a smoother coating and some preferred polymeric coating materials form crystallites having a size less than 300 Å and total crystallinity less than 70% or 65% as determined by X-ray analysis. The good coalescing of polymeric coating particles is confirmed by DSC analysis with materials exhibiting at least one peak or shoulder at a temperature of less than 100° C. on a cooling curve when the materials are cooled at a rate of 1° C./min. Good coalescence resulting in the formation of smoother coatings is also confirmed by 3D Surface Topography analysis. Preferred coating materials with a total crystallinity >36% but lower than 70% or 65% as determined by X-ray analysis, can result in coatings having a favorable balance of Water Vapor Transmission Rate and particle coalescence.

The polymeric coating is typically added to the fiber-based layer after the fiber-based layer has been molded into its desired configuration. As such, the polymeric coating can be applied as a powder to the fiber-based material layer. Polymeric powder particles can have an average size of from about 1 micron to about 200 microns; for example, from about 5 microns to about 100 microns, or from about 10 microns to about 50 microns.

Some useful polymeric coating materials are sold in pellet form. The pellets can be converted to particles having a desired size and size distribution. Care should be taken selecting any processing aids for a pellet to particle conversion so that any residual processing aids are either present in insignificant amounts or can be removed through a rinsing or other removal step so that the residual material does not interfere with coalescing into a final coating form on the containers. For example, surfactants should preferably either be absent from a pellet to particle conversion or be removable (at least in part) from the resulting particles. Methods by which the pellets can be converted into particles can include dispersion, emulsion polymerization, spraying, electrospraying and direct synthesis.

Powder application can occur through an electrostatic high-voltage process, for example an ionization process or a corona process, or a triboelectric or an electrokinetic friction process, followed by baking the bottle in a sintering furnace, wherein during the sintering process a crystalline phase grows by spherulitic crystallization and the crystallization growth occurs by adding nucleating agent and maintaining the temperature between the glass transition temperature (TG) and the crystallite melting point (Ts). This can allow particularly high crystalline proportions to form and a homogeneous layer of polymeric material to be created through sintering. Optionally, the polymeric coating can be applied by roto-molding, dip coating, spray coating, or combinations thereof.

One suitable powder-coating method is described in U.S. Pat. Appl. No. US 2024/0167228 A1, incorporated herein by reference. A spraying gun or other spraying device charges the polymeric powder prior to or during deposition. The polymeric particles can be charged by corona charging which applies a negative or positive charge to the particles allowing them to strongly adhere to desired portions of the fiber-based material layer.

The weight ratio of fiber-based material layer to polymeric coating may be at least 70:30, preferably at least 80:20, 90:10, or even 95:5. In this context a weight ratio of “at least X:Y” should be understood as encompassing any value of ratio X1:Y1 where X1≥X and where Y1≤Y. These ratios can be beneficial for the bottle/container to be processed according to various recycling streams.

Container walls can have a thickness, including a combination of the fiber-based material and the polymeric coating, of at least 0.3, 0.4, 0.5, 0.6, 0.7, 1.0 millimeters or even greater.

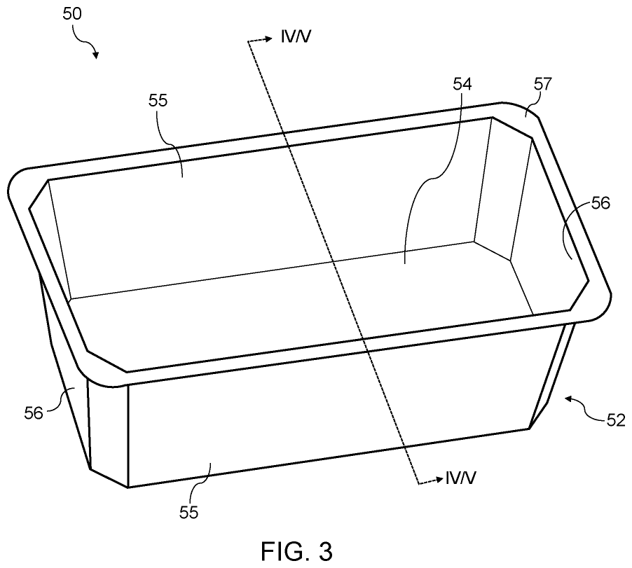

As noted above, containers of the present invention can take various forms, including bottles, cartons, trays, and the like. FIGS. 1 and 2 show one exemplary container in the form of a bottle. FIGS. 3 to 5 show another exemplary container 50 in the form of a tub. Container 50 comprises a body 52 that includes a bottom 54, two side walls 55 extending from bottom 54, and two end walls 56 also extending from bottom 54. A top rim 57 is included to receive an optional closure, which can include a polymer film, a fiber-based substrate comprising a polymeric coating (such as that disclosed herein), or other materials and configurations. Containers in the form of a tub can be useful for storing pre-moistened wipes or mopping pads comprising a cleaning composition.

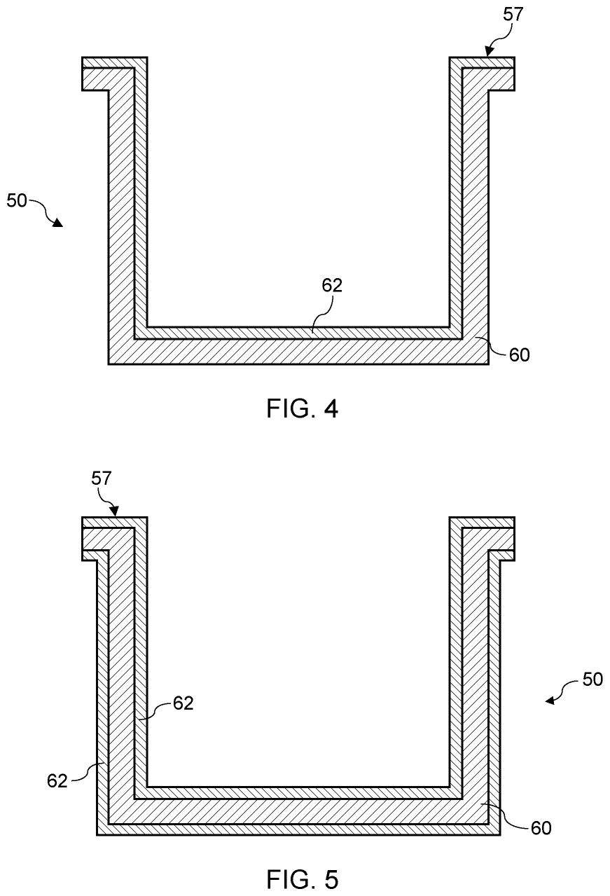

FIGS. 4 and 5 are alternative cross-sections of container 50, taken along line IV/V-IV/V in FIG. 3. FIG. 4 shows a container comprising a fiber-based material layer 60 with a polymeric coating 62 on an interior of container 50 and on top rim 57. FIG. 5 shows a container comprising a fiber-based material layer 60 with a polymeric coating 62 on both an interior and exterior of container 50, and on top rim 57. While not shown, the polymeric coating can exist on just the exterior of containers provided herein.

The containers of the present invention, depending on their form, may or may not have a closure. If employed, a closure may be completely removable or may stay at least partially attached to the container body. If employed, a closure may comprise a fiber-based material layer or be constructed from other materials. And if employed, a closure may comprise a polymeric material that is the same or different from that of the polymeric coating materials described herein. Such a difference can relate to any number of aspects, including, for example, material composition, density, molecular weight, tensile flexural modulus, material form (e.g., injection or blow molded versus coalesced polymer particles), other physical properties, other chemical properties, aesthetics (e.g., color or post-formed treatment), and recyclability.

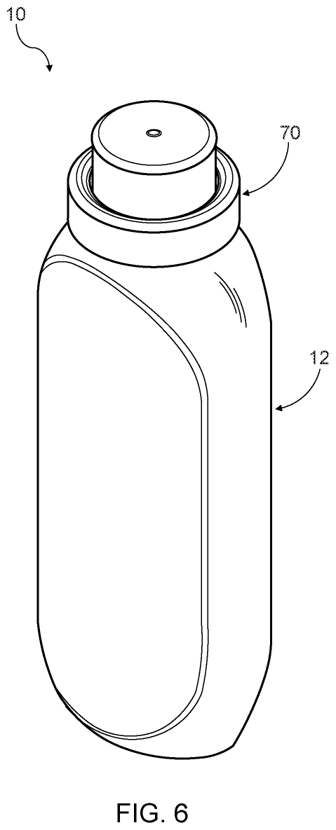

By way of example only, FIG. 6 shows bottle 10, from FIG. 1, with a removable cap 70. In one form, bottle body 12 comprises a fiber-based material layer with polymeric coating comprising LDPE or LLDPE, and cap 70 comprises HDPE or PP. In another form, bottle body 12 comprises a fiber-based material layer with a polymeric coating comprising greater than 50 wt % of LDPE and/or LLDPE, while cap 70 comprises greater than 50 wt % of a polymer other than LDPE or LLDPE. While not required, utilizing two different polymers for the polymeric coating and a closure has been found to provide a good closure seal.

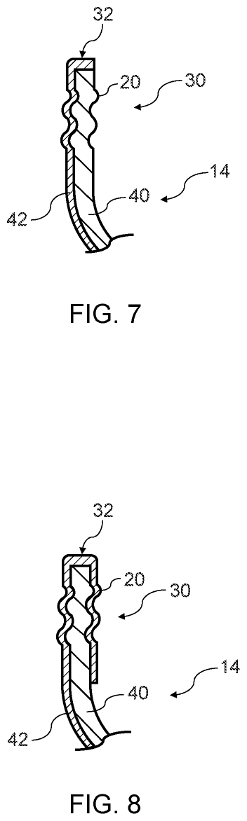

FIGS. 7 and 8 show a partial cross-section of the neck finish 30 of bottle 10 shown in FIG. 1. Polymeric coating 42 in FIG. 7 is disposed on a portion of fiber-based material layer 40 that defines an interior of bottle neck 14, and on a neck edge 32. Alternatively, polymeric coating 42 can be disposed on portions of fiber-based material layer 40 that define both an interior and exterior (at least partially) of bottle 10 in its neck finish 30, as shown in FIG. 8. Neck finish 30 comprises a thread 20 that engages a mating thread on cap 70 (shown in FIG. 6).

Containers of the present invention can store and dispense liquids, solids, or mixed product compositions. The containers provided herein can include compositions for or related to (a) fabric or laundry conditioning (including softening, freshening, wrinkle removal or prevention, stain prevention, or modification of properties of fabric or clothing), (b) fabric or laundry detergency (including, cleaning or stain removal), (c) laundry rinse additives or care, hard surface cleaning or treatment, (d) air care (including air freshening, purification, or malodor prevention, removal, or control), (e) car care (including air care, fabric care, or hard surface care in cars, trucks, or other vehicles), and (f) dishwashing. A few composition examples are described in greater detail below.

### Containers Comprising Laundry Detergent Compositions

Containers of the present invention can include a laundry detergent composition. Typically, laundry detergent compositions comprise a surfactant in an amount sufficient to provide desired cleaning properties. For example, a laundry detergent composition can comprise, by weight, from about 5% to about 90% of a surfactant, and more specifically from about 5% to about 70% of a surfactant, and even more specifically from about 5% to about 40%. The surfactant may comprise anionic, nonionic, cationic, zwitterionic and/or amphoteric surfactants. By way of example only, a detergent composition can comprise an anionic surfactant, an nonionic surfactant, or mixtures thereof.

Exemplary anionic surfactants include, but are not limited to, the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂, LAS is a specific example of such surfactants.

Another exemplary type of anionic surfactant comprises ethoxylated alkyl sulfate surfactants. Such materials, also known as alkyl ether sulfates or alkyl polyethoxylate sulfates, are those which correspond to the formula: R′—O—(C₂H₄O)ₙ—SO₃M wherein R′ is a C₈-C₂₀ alkyl group, n is from about 1 to 20, and Mis a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6 and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate materials, i.e., surfactants of the above ethoxylated alkyl sulfate formula wherein n=0. Non-ethoxylated alkyl sulfates may also be added separately to the compositions and used as or in any anionic surfactant component which may be present. Specific examples of non-alkoyxylated, e.g., non-ethoxylated, alkyl ether sulfate surfactants are those produced by the sulfation of higher C₈-C₂₀ fatty alcohols. Conventional primary alkyl sulfate surfactants have the general formula: ROSO₃⁻M⁺ wherein R is typically a linear C₈-C₂₀ hydrocarbyl group, which may be straight chain or branched chain, and M is a water-solubilizing cation. In specific forms, R is a C₁₀-C₁₅ alkyl, and Mis alkali metal, more specifically R is C₁₂-C₁₄ and M is sodium.

Specific, nonlimiting examples of anionic surfactants include a) C₁₁-C₁₈ alkyl benzene sulfonates (LAS); b) C₁₀-C₂₀ primary, branched-chain and random alkyl sulfates (AS); c) C₁₀-C₁₈ secondary (2,3) alkyl sulfates having formulae (I) and (II):

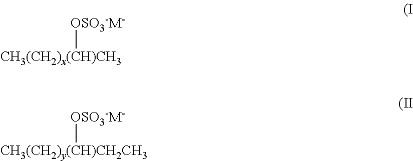

wherein M in formulae (I) and (II) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of preferred cations including sodium, potassium, ammonium, and mixtures thereof, and x is an integer of at least about 7, preferably at least about 9, and y is an integer of at least 8, preferably at least about 9; d) C₁₀-C₁₈ alkyl alkoxy sulfates (AEₓS) wherein preferably x is from 1-30; e) C₁₀-C₁₈ alkyl alkoxy carboxylates preferably comprising 1-5 ethoxy units; f) mid-chain branched alkyl sulfates as discussed in U.S. Pat. Nos. 6,020,303 and 6,060,443; g) mid-chain branched alkyl alkoxy sulfates as discussed in U.S. Pat. Nos. 6,008,181 and 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (MES); and j) alpha-olefin sulfonate (AOS).

Suitable nonionic surfactants can comprise any of the conventional nonionic surfactant types typically used in liquid detergent products. These include alkoxylated fatty alcohols and amine oxide surfactants.

Exemplary nonionic surfactants include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one form, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials will frequently have a hydrophilic-lipophilic balance (HLB) which ranges from about 3 to 17. More preferably, the HLB of this material will range from about 6 to 15, most preferably from about 8 to 15.

Another suitable type of nonionic surfactant comprises the amine oxide surfactants. Amine oxides are materials which are often referred to in the art as “semi-polar” nonionics. Amine oxides have the formula: R(EO)ₓ(PO)_{y}(BO)_{z}N(O)(CH₂R′)₂·qH₂O. In this formula, R is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Non-limiting examples of nonionic surfactants include: a) C₁₂-C₁₈ alkyl ethoxylates, such as, NEODOL® nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as Pluronic® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x 1-30, as discussed in U.S. Pat. Nos. 6,153,577, 6,020,303 and 6,093,856; f) Alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

The detersive surfactant component may comprise combinations of anionic and nonionic surfactant materials, with the weight ratio of anionic to nonionic in the range from 10:90 to 90:10, or from 30:70 to 70:30.

Cationic surfactants are well known in the art and non-limiting examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002, WO 98/35003, WO 98/35004, WO 98/35005, and WO 98/35006; d) cationic ester surfactants as discussed in U.S. Pat. Nos. 4,228,042, 4,239,660 4,260,529 and U.S. Pat. No. 6,022,844; and e) amino surfactants as discussed in U.S. Pat. No. 6,221,825 and WO 00/47708, specifically amido propyldimethyl amine (APA).

Non-limiting examples of zwitterionic surfactants include derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Exemplary ampholytic surfactants include aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

Laundry detergent compositions can include a hueing dye. Exemplary dyes which exhibit the combination of hueing efficiency and wash removal value include certain triarylmethane blue and violet basic dyes, methine blue and violet basic dyes, anthraquinone dyes, anthraquinone dyes basic blue 35 and basic blue 80, azo dyes basic blue 16, basic blue 65, basic blue 66 basic blue 67, basic blue 71, basic blue 159, basic violet 19, basic violet 35, basic violet 38, basic violet 48, oxazine dyes basic blue 3, basic blue 75, basic blue 95, basic blue 122, basic blue 124, basic blue 141, Nile blue A and xanthene dye basic violet 10, and mixtures thereof. Other suitable hueing dyes are found in U.S. Pat. Nos. 4,137,243, 5,591,833, and 6,458,193, to Milliken Research Corporation, incorporated herein by reference. U.S. Pat. No. 4,137,243 describes alkoxylated anthraquinone polymeric colorants, including a 3 ring anthraquinone chromophore with variable substituents, including a polymeric chain. In one form, the hueing dye is a triphenylmethane based polymeric colorant such as those described in U.S. Pat. No. 4,871,371 and/or an alkoxylated thiophene based polymeric colorant such as those described in U.S. Pat. No. 4,601,725.

Laundry detergent compositions can comprise an opacifying agent. As used herein, the term “opacifying agent” refers to a material which, when added to a composition having a transmittance of from about 55% to 100% when measured at 440 nm wavelength, is capable of producing a composition having a transmittance reading of about 20% or less when measured at a 440 nm wavelength. The amount and type of opacifying agent used will depend on the particular composition and how much is necessary to produce a composition with a transmittance of less than about 20%, preferably from about 15% to about 0.1%. In one form, the composition comprises from about 0.02% to about 0.5%, by weight of the composition, of an opacifying agent, more preferably from about 0.05% to about 0.4%, more preferably from about 0.1% to about 0.25%.

Opacifying agents can include particles having a mean particle size of from about 50 nanometers to about 300 microns, preferably from about 100 nanometers to about 200 microns, more preferably from about 100 nanometers to about 500 nanometers, more preferably from about 150 nanometers to about 300 nanometers. Exemplary opacifying agents include acrylic or styrene-based polymers, and polyacrylate/polystyrene copolymers.

Laundry detergent compositions may comprise, by weight, from about 5% to about 90%, more specifically from about 10% to about 70%, and even more specifically from about 20% to about 70% of an aqueous, non-surface active liquid carrier. Water is an effective liquid carrier. Other types of water-miscible liquids, such alkanols, diols, other polyols, ethers, amines, and the like, can be added as co-solvents or stabilizers. In one form, the aqueous liquid carrier component of liquid laundry detergent compositions will generally comprise water present in concentrations ranging from about 5% to about 90%, more preferably from about 20% to about 70%, by weight of the composition.

Laundry detergent compositions can also include any number of additional optional ingredients. These can include, for example, detersive builders, enzymes, enzyme stabilizers (such as propylene glycol, boric acid and/or borax), suds suppressors, soil suspending agents, soil release agents, other fabric care benefit agents, pH adjusting agents, chelating agents, smectite clays, solvents, hydrotropes and phase stabilizers, structuring agents, dye transfer inhibiting agents, optical brighteners, perfumes and coloring agents. The various optional detergent composition ingredients should be utilized at concentrations conventionally employed to bring about their desired contribution to the composition or the laundering operation. By way of example only, the total amount of such optional detergent composition ingredients can range from about 0.1% to about 50%, more preferably from about 1% to about 30%, by weight of the composition.

### Containers Comprising Fabric Enhancing Compositions

Containers of the present invention can include a fabric enhancing composition. Exemplary fabric enhancing compositions comprise water, one or more active agents, and perfume. In some forms, the fabric enhancing composition includes from about 40% to about 98%, from about 50% to about 96%, from about 75% to about 95%, or from about 80% to about 94%, by weight of the composition, of water.

Fabric enhancing compositions can include fabric conditioning agents useful for providing benefits such as softness, anti-wrinkle, anti-static, conditioning, anti-stretch, color, and/or appearance benefits. A non-limiting list of conditioning agents includes quaternary ester softening agents, such as monoester quats, diester quats, and triester quats; silicones; non-ester quaternary ammonium compounds; amines; fatty esters; sucrose esters; dispersible polyolefins; polysaccharides; fatty acids; softening or conditioning oils; polymer latexes; glyceride copolymers; and mixtures thereof. Commercially available quaternary ammonium ester softening agents include TETRANYL AT-1 and TETRANYL AT-7590 from KAO Chemicals, REWOQUAT WE16 DPG, REWOQUAT WE18, REWOQUAT WE20, REWOQUAT WE28, and REWOQUAT 38 DPG from Evonik, and STEPANTEX GA90, STEPANTEX VR90, STEPANTEX VK90, STEPANTEX VA90, and STEPANTEX VL90A from Stepan. Conditioning agents can be included in the fabric enhancing compositions at a level from about 2% to about 20%, by weight of the composition.

The fabric enhancing compositions may comprise perfume, a perfume delivery system, or a combination thereof. Such systems may improve the freshness performance of the compositions described herein. In particular, perfume delivery systems may facilitate improved freshness performance by increasing deposition efficiency, facilitating perfume release at different touchpoints, and/or increasing longevity of perfume performance.

Perfume may be present as neat oil, sometimes referred to as, for example, “free” perfume, unencapsulated perfume, or free perfume oil. The fabric enhancing compositions may comprise from about 0.01% to about 5%, or from about 0.05% to about 4%, or from about 0.1% to about 3%, or from about 0.5% to about 2%, by weight of the composition, or free perfume oil.

Neat oil can comprise perfume raw materials such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, alpha-damascone, beta-damascone, gamma-damascone, beta-damascenone, 6,7-dihydro-1,1,2,3,3-pentamethyl-4 (5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and beta-dihydro ionone, linalool, ethyllinalool, tetrahydrolinalool, and dihydromyrcenol. Perfume raw materials and perfume compositions can be obtained from Givaudan Corp. of Mount Olive, New Jersey, USA, International Flavors & Fragrances Corp. of South Brunswick, New Jersey, USA, and Firmenich Company of Geneva, Switzerland or Encapsys Company of Appleton, Wisconsin (USA). As used herein, a “perfume raw material” refers to one or more of the following ingredients: fragrant essential oils; aroma compounds; pro-perfumes; materials supplied with the fragrant essential oils, aroma compounds, and/or pro-perfumes, including stabilizers, diluents, processing agents, and contaminants; and any material that commonly accompanies fragrant essential oils, aroma compounds, and/or pro-perfumes.

A perfume delivery system may be employed in the fabric enhancing compositions. The perfume delivery system may comprise encapsulates, for example, where a core is surrounded by wall material (“core-shell encapsulates”); the core may comprise perfume and optionally a partitioning modifier (e.g., isopropyl myristate). The wall material may include melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, or mixtures thereof. The melamine wall material may comprise melamine crosslinked with formaldehyde, melamine-dimethoxyethanol crosslinked with formaldehyde, and mixtures thereof; encapsulates with such wall materials may be used in combination with a formaldehyde scavenger, such as acetoacetamide, urea, or derivatives thereof. The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The wall (or shell) may degrade at least 50% after 20 days (or less) when tested according to test method OECD 301B. The wall may preferably degrade at least 60% of its mass after 60 days (or less) when tested according to test method OECD 301B. The wall may degrade from 30-100%, preferably 40-100%, 50-100%, 60-100%, or 60-95%, in 60 days, preferably 50 days, more preferably 40 days, more preferably 28 days, more preferably 14 days.

The fabric enhancing composition may comprise from about 0.05% to about 20%, or from about 0.05% to about 10%, or from about 0.1% to about 5%, or from about 0.2% to about 2%, by weight of the composition, of delivery particles. The composition may comprise a sufficient amount of delivery particles to provide from about 0.05% to about 10%, or from about 0.1% to about 5%, or from about 0.1% to about 2%, by weight of the composition, of the encapsulated benefit agent, which may preferably be perfume raw materials, to the composition. When discussing herein the amount or weight percentage of the delivery particles, it is meant the sum of the wall material and the core material.

The delivery particles may be characterized by a volume-weighted median particle size from about 1 to about 100 microns, preferably from about 10 to about 100 microns, preferably from about 15 to about 50 microns, more preferably from about 20 to about 40 microns, even more preferably from about 20 to about 30 microns. Different particle sizes are obtainable by controlling droplet size during emulsification. The delivery particles may be characterized by a ratio of core to wall up to 99:1, or even 99.5:1, on the basis of weight.

The encapsulates may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, a polysaccharide (e.g., chitosan), and combinations thereof.

The perfume delivery system may comprise particles that comprise a graft copolymer and a fragrance material, where the graft copolymer comprises a polyalkylene glycol (e.g., polyethylene glycol) as a graft base and one or more side chains that comprise vinyl acetate moieties.

The perfume delivery system may comprise a pro-perfume, for example a siloxane-based pro-perfume, where a perfume raw material is associated with (e.g., via covalent bonding) a polymer (e.g., a siloxane polymer) upon delivery to a surface and is released upon or after treatment of a surface with the composition.

When the perfume delivery system includes formaldehyde derivatives, such as perfume encapsulates with melamine-formaldehyde walls, the composition may further comprise a formaldehyde scavenger, which may comprise a sulfur-based formaldehyde scavenger, a non-sulfur-based formaldehyde scavenger, or mixtures thereof. Suitable non-sulfur-based formaldehyde scavengers may include urea, ethylene urea, acetoacetamide, or mixtures thereof. Suitable sulfur-based formaldehyde scavengers may include alkali and/or alkali earth metal dithionites, pyrosulfites, sulfites, bisulfites, metasulfites, monoalkyl sulphites, dialkyl sulphites, dialkylene sulphites, sulfides, thiosulfates, thiocyanates, mercaptans, thiourea, and mixtures thereof.

Fabric enhancing compositions may include other treatment adjunct ingredients. The adjunct ingredients may be selected to provide, for example, processing, stability, and/or performance benefits. Suitable treatment adjuncts may include surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, structurants, anti-agglomeration agents, coatings, formaldehyde scavengers, and/or pigments. In particular, the fabric enhancing composition may further comprise a treatment adjunct selected from the group consisting of conditioning agents, dyes, pH control agents, solvents, rheology modifiers, structurants, cationic polymers, surfactants, chelants, antioxidants, preservatives, or mixtures thereof. The precise nature of these additional components, and levels of incorporation thereof, will depend on the physical form of the composition and the nature of the operation for which the resulting composition is to be used.

### Containers Comprising Unit Dose Compositions

Containers of the present invention can be useful for storing unit dose compositions. Exemplary unit dose compositions are formulated for cleaning clothing, home fabrics, home surfaces, dishes, home appliances such as toilets, dishwashers, and washing machines. In some aspects, the unit dose compositions comprise water-soluble components in the form of films and/or fibers. Such films and/or fibers can be made from materials including polyvinyl alcohol, cellulosics, starches, and polylactic acid, for example.

The polymeric coating employed in the containers of the present invention can help protect the compositions from unwanted moisture prior to using the unit dose compositions. As such, containers of the present invention can be used in the place of traditional packaging configurations that are entirely constructed from plastic materials. The polymeric coating can be employed on inner surfaces, outer surfaces, or both of the containers that store unit dose compositions.

### Containers Comprising Pre-Moistened Wipes and Pads

Containers provided herein are useful for storing pre-moistened wipes that are used to clean various hard surfaces in residential or commercial buildings. Similarly, pre-moistened pads that are removably attachable to a mop or other implement can be stored in containers of the present invention. Pre-moistened wipes and pads have historically been packaged in flexible or rigid plastic containers. The containers comprising a fiber-based material and polymeric coating are capable of providing similar protection to the wipes and pads, while also utilizing less plastic.

### EXAMPLES

Table 1 below includes three Inventive Examples and three Comparative Examples related to the polymeric coating materials. It should be understood that the Inventive Example materials can be used alone for the polymeric coating of the present invention containers, or alternatively in polymer blends, even including some of the Comparative Example materials where the polymer blends comprise properties and/or can provide results consistent with the operable aspects described herein.

TABLE 1
Polymeric Coating Materials

| | Trade-Name | Material |
|---|---|---|
| Inventive | Lucalen A2700M | Low-density polyethylene with a butyl acrylate |
| Example A | | copolymer |
| Inventive | Lupolen 3621 M | Linear low-density polyethylene with a hexene |
| Example B | RM | copolymer |
| Inventive | EXCEED 0015XC | Linear low-density polyethylene with a hexene |
| Example C | | copolymer |
| Comparative | Microthene | High-density polyethylene with an octene copolymer |
| Example D | FA70900 | |
| Comparative | Tipelin 6300B | High-density polyethylene with a butene copolymer |
| Example E | | |
| Comparative | Purell GA 7760 | High-density polyethylene |
| Example F | | |

Table 2 below shows a pass/fail Environmental Stress Creak Resistance (“ESCR”) outcome for containers made with some of the polymeric coating materials listed in Table 1 and containing an exemplary liquid laundry detergent composition. The ESCR Pass/Fail results in Table 2 are reported at 1 month at 50° C. and a 1.2 kg load.

TABLE 2
ESCR of Material Alone & Formed Into Bottles

| | | Material ESCR ASTM | Material ESCR |
|---|---|---|---|
| Polymeric Coating | ESCR Pass/Fail | 1693-15 F50 | FNCT ISO 16670 |
| Material | (Filled Bottle) | (Bell Telephone Test) | (2019) |
| Inventive Example A | Pass | >1000 | Material too soft |
| | | | to utilize this test |
| Inventive Example B | Pass | >1000 | 60.6 |
| Inventive Example C | Pass | >1000 | |
| Comparative Example D | Fail | 22.2 | 0.22 |
| Comparative Example F | Fail | <1 | <1 |

Operable polymeric coating materials exhibit good melt flow properties so that particles (when a polymeric powder is employed) can coalesce more effectively and efficiently into neighboring particles. Two techniques for evaluating the melt flow properties include elongational elasticity (using Goettfert Rheotens Elongational Tester or equivalent) and Melt Flow Index (“MFI”). Polymeric coating materials having a melt elasticity characterization of velocity at break of greater than 250, 500, 700, or 800 mm/s, as measured with the Goettfert Rheotens Elongational Tester, yielded good barrier properties for containers suitable for storing liquid laundry detergent compositions. Table 3 below shows melt elasticity values for some of the examples listed in Table 1.

TABLE 3
Melt Elasticity

| | Melt Elasticity, | Melt Flow Index |
|---|---|---|
| | velocity at break | (g/10 min @ 190° |
| Example | (mm/s) | C./2.16 kg) |
| Inventive Example A | 870.90 | 7.2 |
| Inventive Example B | 924.98 | 7.5 |
| Inventive Example C | 509.79 | 15 |
| Comparative Example D | 59.54 | 10 |
| Comparative Example E | 179.92 | 0.3 |

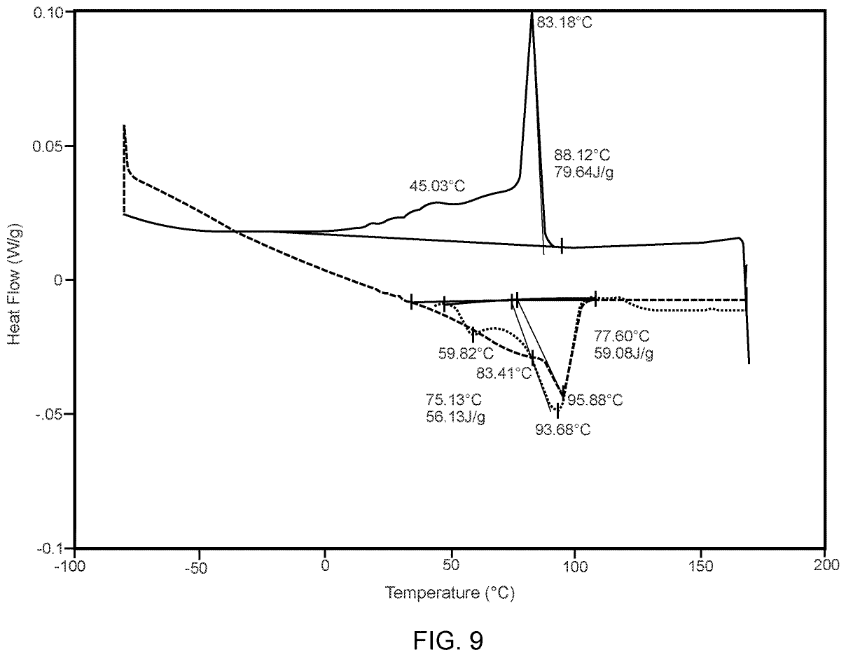

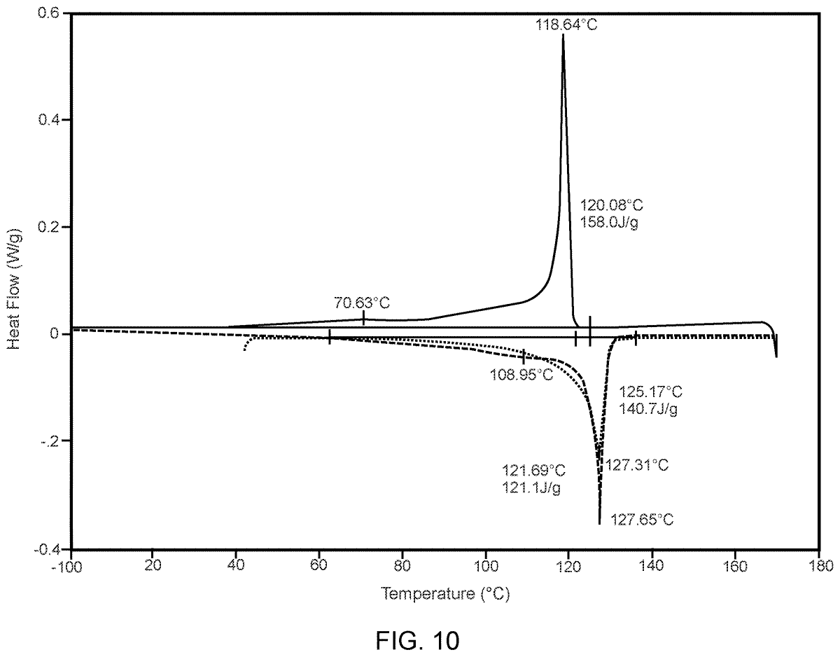

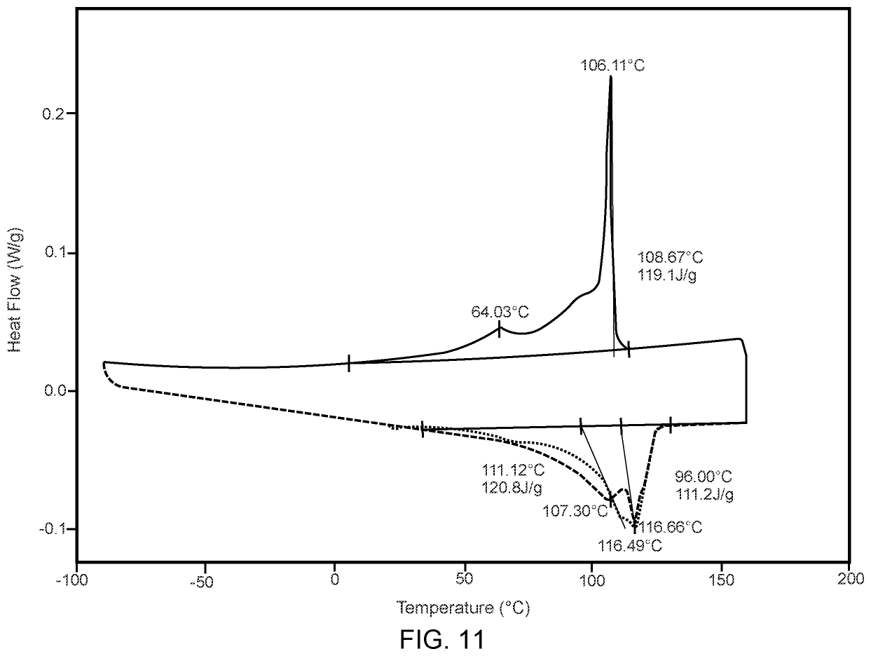

Differential Scanning calorimetry (“DSC”) can indicate whether a polymer will melt at a low temperature, which in turn, affects the temperature at which the material can flow and coalesce. FIGS. 9 to 11 show DSC curves for some of the examples listed in Table 1. Polymeric coating materials that may provide good barrier properties for the containers of the present invention can exhibit at least one peak or shoulder below 100° C., below 90° C., or below 80° C. on a DSC cooling curve generated at a cooling speed of 1° C./minute. DSC curves for Inventive Examples A, B, and C are shown in FIGS. 9, 10, and 11, respectively. FIG. 9 shows a peak or shoulder at 45.03° C. from Inventive Example A. FIG. 10 shows a peak or shoulder at 70.63° C. from Inventive Example B. FIG. 9 shows a peak or shoulder at 64.03° C. from Inventive Example C.

Relative crystallinity and average crystallite size were evaluated for the Inventive Example materials A, B, and C, along with Comparative Example D. Table 4 below includes the results from DSC, as well as X-ray scatter analysis (SAXS/WAXS).

TABLE 4
Relative Crystallinity and Average Crystallite Size

| | Inventive | Inventive | Inventive | Comparative |
|---|---|---|---|---|
| | Example A | Example B | Example C | Example D |
| Relative | 36 | 63 | 52 | 69 |
| crystallinity | | | | |
| (%) | | | | |
| Average | 130 | 261 | 192 | 253 |
| crystallite | | | | |
| size | | | | |
| (Angstroms) | | | | |

Polymeric coating materials that have good melt flow properties, including good coalescing properties when utilizing polymeric particles can result in a relatively smooth coating on the fiber-based material layer. This can provide a robust barrier, as well as enable a thinner coating thickness so that a higher ratio of fiber-based material to polymeric coating (e.g., 90:10 or 95:5) can be obtained for the containers described herein.

A 1.5 mm by 2.0 mm sample from containers comprising a fiber-based material layer and a polymeric coating comprising some of the materials in Table 1 were evaluated optically using 3D surface topography. Structured-light instruments such as the LMI MikroCAD platform can be used for this optical evaluation, and data can be analyzed with appropriate software, such as, for example, Digital Surf MountainsMap. A second-order polynomial was used to correct for the curvature of the container sample and then a robust gaussian filter was applied. Images with both polynomial correction and robust gaussian filter applied were analyzed with output metrics defined in ISO 25178. Table 5 below shows the average from three samples of the root mean square height (S_q), the height difference between the height corresponding to 5% and 95% in the cumulative distribution of height readings within the image (S_dc), and the percentage increase over the projected 2D surface area (S_dr).

TABLE 5
3D Surface Topography

| Example | S_q (microns) | S_dc (microns) | S_dr, (%) |
|---|---|---|---|
| Inventive Example A | 6.07 | 17.92 | 25.69 |
| Inventive Example B | 5.41 | 16.87 | 31.72 |
| Inventive Example C | 5.36 | 16.91 | 24.87 |
| Comparative Example D | 14.49 | 48.78 | 133.50 |

Polymeric coating materials exhibiting S_dc values of less than 40 microns are preferred for containers of the present invention. Polymeric coating materials that exhibit S_dc values greater than 40 microns may however still be used depending on their melt flow and physical properties.

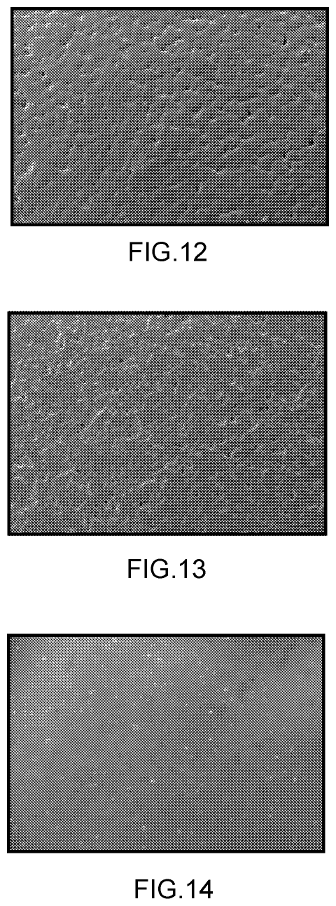

Scanning Electron Microscope (“SEM”) images were captured from additional samples of containers comprising a fiber-based material layer and a polymeric coating comprising some of the materials in Table 1. FIGS. 12 to 14 show SEM images of containers embodying a polymeric coating material. As one can see from FIG. 14, Inventive Example A material results in a smoother polymeric coating in comparison to a polymeric coating using Comparative Example D and F materials, shown in FIGS. 12 and 13, respectively.

### Test Methods

A. Environmental Stress Crack Resistance F50 (Bell Telephone) Test: ASTM 1693-15 (condition B, 10% Igepal, 50° C. used)
B. Environmental Stress Crack Resistance, Full Notch Creep Test: ISO 16670 (2019; 10% Caflon NP9, 50° C. used)
C. Melt Flow Rate: ASTM D1238
D. Polymer Density: ASTM D1505
E. Melt Elasticity—can be analyzed via Goettfert Rheotens elongational tester.
F. Polymer Molecular Weight and Molecular Weight Distribution: can be analyzed via Gel Permeation Chromatography. A GPC-RI (HTGPC) instrument with accompanying data acquisition and analysis software package can be used.
G. X-ray scattering/analysis is performed in the SAXS/WAXS range.
H. Scanning Electron Microscope (“SEM”): a Zeiss Ultra Plus SEM instrument from Carl Zeiss AG was used to generate the SEM images herein.
I. Differential Scanning calorimetry Analysis: A TA Instruments Q2000 DSC instrument equipped with a refrigerated cooling accessory (RCS90) can be used. The instrument is initially purged with nitrogen at a flow rate of 50 mL/min. Samples are then subjected to the following temperature cycles heating from 20° C. to 160° C., followed by cooling to −90° C., and then reheating to 160° C., all at a temperature change rate of 1° C./min. Curves are generated that include distinct exothermic and endothermic peaks. The area spanning points on either side of an identified peak can be integrated to evaluate the amount of energy absorbed or released (enthalpy reported in units of J/g) by material samples during melting and crystallization. Of particular interest, and as noted above, is the existence of any peaks on the cooling curve below 100° C. that can inform how a material coalesces and crystallizes thereafter.

### Exemplary Products

A. A product, comprising:
   a. a container comprising a body comprising a cavity for storing a product composition therein;
   b, wherein the body comprises a fiber-based material layer and a polymeric coating; and
   c, wherein the container is capable of storing a product composition that is liquid and that includes a surfactant and/or perfume.
B. The product of Paragraph A, wherein the polymeric coating comprises polyethylene repeat units.
C. The product of Paragraph A, wherein the polymeric coating comprises low-density polyethylene.
D. The product of Paragraph A, wherein the polymeric coating comprises linear low-density polyethylene.
E. The product of Paragraph A, wherein the polymeric coating comprises a polymer blend that includes a first polymer comprising low-density polyethylene or linear low-density polyethylene, a second polymer that is different from the first polymer.
F. The product of any one of the preceding paragraphs, wherein the product comprises a ratio of fiber-based material to polymeric coating of at least 70:30.
G. The product of any one of the preceding paragraphs, wherein the product comprises a ratio of fiber-based material to polymeric coating of at least 95:5.
H. The product of any one of the preceding paragraphs, wherein the polymeric coating comprises at least 30% post-consumer recycled material.
I. The product of any one of the preceding paragraphs, wherein the polymeric coating comprises a material having an Environmental Stress Crack Resistance F50 value, according to ASTM 1693-15 Bell Telephone Test (Cond B, 10% Igepal, 50C), of greater than 500 hours.
J. The product of any one of the preceding paragraphs, wherein the polymeric coating comprises a material having an Environmental Stress Crack Resistance F50 value, according to ASTM 1693-15 Bell Telephone Test (Cond B, 10% Igepal, 50C), of greater than 1,000 hours.
K. The product of any one of the preceding paragraphs, wherein the polymeric coating comprises a material having a melt flow rate, according to ISO 1133, of greater than 2.5 g/10 min.
L. The product of any one of the preceding paragraphs, wherein the polymeric coating comprises a material having a melt flow rate, according to ISO 1133, of greater than 5 g/10 min.
M. The product of any one of the preceding paragraphs, wherein the polymeric coating comprises a material having a melting enthalpy of less than 170 J/g as determined by DSC.
N. The product of any one of the preceding paragraphs, wherein the polymeric coating comprises a material that forms crystallites sized less than 300 Å and with total crystallinity less than 70% as determined by X-ray analysis.
O. The product of any one of the preceding paragraphs, wherein the polymeric coating comprises a material having a ESCR FNCT ISO 16670 (2019) value of greater than 10 hours.
P. The product of any one of the preceding paragraphs, wherein the polymeric coating comprises a material having a melt elasticity characterization of velocity at break of greater than 250 mm/s.
Q. The product of any one of the preceding paragraphs, wherein the polymeric coating comprises a material that exhibits at least one peak or shoulder below 100° C. on a cooling curved cooled when cooled at a speed of 1° C./min according to a Differential Scanning calorimetry analysis of the material.
R. The product of any one of the preceding paragraphs, wherein the polymeric coating comprises a surface smoothness characterized by a height difference of less than 40 microns between a height corresponding to 5% and 95% in a cumulative distribution of height readings within an image analyzed by 3D surface topography.
S. The product of any one of the preceding paragraphs, wherein the polymeric coating comprises a material that is derived from a polymer or polymer blend that crystalizes at a temperature of less than 100° C. during cooling.
T. The product of any one of the preceding paragraphs, wherein the polymeric coating comprises a material having a density, according to ASTM D1505, that is less than 0.94 g/cm³.
U. The product of any one of the preceding paragraphs, wherein the polymeric coating comprises a polymer having a molecular weight of from about 100,000 to about 250,000 g/mol.
V. The product of any one of Paragraphs A to U, wherein the container is in the form of a bottle.
W. The product of any one of Paragraphs A to U, wherein the container is in the form of a tub.
X. The product of any one of Paragraphs A to U, wherein the container is in the form of a tray.
Y. The product of any one of the preceding paragraphs, further comprising a container closure, wherein the polymeric coating comprises more than 50%, by weight of the coating, of a polymeric material having a density that is less than 0.94 g/cm³, and wherein the container closure comprises more than 50%, by weight of the container closure, of a polymeric material other than a polyethylene.
Z. The product of any one of the preceding paragraphs, further comprising a container closure, wherein the polymeric coating is derived from a polymer or polymer blend that crystalizes at a temperature of less than 100° C., and wherein the container closure comprises a polymeric material that crystalizes at a temperature of greater than 100° C.
AA. The product of any one of the preceding paragraphs, further comprising a container closure, wherein the polymeric coating comprises a polymeric material that has a glass transition temperature of below −50° C., and wherein the container closure comprises a polymeric material that has a glass transition temperature of above −20° C.
BB. The product of any one of the preceding paragraphs, further comprising a container closure, wherein a ratio of fiber-based material to polymeric coating is at least 70:30, and wherein the container closure comprises more than 30%, by weight of the container closure, of a polymeric material.
CC. The product of any one of Paragraphs A to BB, wherein the container comprises a fabric enhancing product composition.
DD. The product of any one of Paragraphs A to BB, wherein the container comprises a product composition comprising a softening agent.
EE. The product of any one of Paragraphs A to BB, wherein the container comprises a laundry detergent product composition.
FF. The product of any one of Paragraphs A to BB, wherein the container comprises a product composition comprising from about 5% to about 40%, by weight of the product composition, of a surfactant.
GG. The product of any one of Paragraphs A to BB, wherein the container comprises a unit dost product composition.
HH. The product of any one of Paragraphs A to BB, wherein the container comprises a pre-moistened cleaning wipe.
II. The product of any one of Paragraphs A to BB, wherein the container comprises a pre-moistened mopping pad.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be understood by those skilled in the art that various other changes and modifications can be made without departing from the spirit and scope of the present disclosure. It is therefore intended to cover in the appended claims all such changes and modifications that are within the scope of the present disclosure.

What is claimed is:

1. A product, comprising:
a. a container comprising a body comprising a cavity for storing a Fabric & Home Care product composition therein;
b. wherein the body comprises a fiber-based material layer and a polymeric coating; and
c. wherein the polymeric coating comprises low-density polyethylene or linear low-density polyethylene.

2. The product of claim 1, wherein the polymeric coating further comprising at least one of:
i. medium-density polyethylene;
ii. very low-density polyethylene; and
iii. high-density polyethylene.

3. The product of claim 1, wherein the polymeric coating further comprising a polymer that is different from low-density polyethylene or linear low-density polyethylene.

4. The product of claim 1, wherein the product comprises a ratio of fiber-based material to polymeric coating of at least 70:30.

5. The product of claim 1, wherein the polymeric coating comprises at least 30% post-consumer recycled material.

6. The product of claim 1, wherein the polymeric coating comprises a material having an Environmental Stress Crack Resistance F50 value, according to ASTM 1693-15, of greater than 250 hours.

7. The product of claim 1, wherein the polymeric coating comprises a material having an Environmental Stress Crack Resistance Full Notch Creep Test, according to ESCR FNCT ISO 16670 (2019), value of greater than 10 hours.

8. The product of claim 1, wherein the polymeric coating comprises a material having an Environmental Stress Crack Resistance Full Notch Creep Test, according to ESCR FNCT ISO 16670 (2019), value of greater than 5 hours.

9. The product of claim 1, wherein the polymeric coating comprises a material having a melt flow rate, according to ISO 1133, of greater than 2.5 g/10 min.

10. The product of claim 1, wherein the polymeric coating comprises a material having a melting enthalpy of less than 170 J/g as determined by DSC.

11. The product of claim 1, wherein the polymeric coating comprises a material that forms crystallites sized less than 300 Å and with total crystallinity less than 70% as determined by WAXS X-ray analysis.

12. The product of claim 1, wherein the polymeric coating comprises a material having a melt elasticity characterization of velocity at break of greater than 250 mm/s.

13. The product of claim 1, wherein the polymeric coating comprises a material that exhibits at least one peak or shoulder below 100° C. on a cooling curve at a cooling speed of 1° C./min according to a Differential Scanning calorimetry analysis of the material.

14. The product of claim 1, wherein the polymeric coating comprises a surface smoothness characterized by a height difference of less than 40 microns between a height corresponding to 5% and 95% in a cumulative distribution of height readings within an image analyzed by 3D surface topography.

15. The product of claim 1, wherein the polymeric coating is derived from a polymer or polymer blend that crystalizes at a temperature of less than 100° C.

16. The product of claim 1, wherein the polymeric coating comprises a material having a density, according to ASTM D1505, that is less than 0.94 g/cm³.

17. The product of claim 1, wherein the polymeric coating has an average molecular weight from about 100,000 to about 250,000 g/mol; and wherein the container has a shelf life of at least 12 months from manufacture wherein there is no leakage of the Fabric & Home Care product composition.

18. A product, comprising:
a. a container comprising a body comprising a fiber-based material layer and a polymeric coating;
b. a liquid product composition disposed in the cavity and selected from the group comprising a fabric or laundry conditioning composition, a fabric or laundry detergent composition, and a laundry rinse additive composition; and
c. a container closure;
d. wherein the polymeric coating comprises more than 50%, by weight of the coating, of a polymeric material having a density that is less than 0.94 g/cm³; and
e. wherein the container closure comprises more than 50%, by weight of the container closure, of a polymeric material other than a polyethylene.

19. A product, comprising:
a. a container comprising a body comprising a fiber-based material layer and a polymeric coating;
b. a liquid product composition disposed in the cavity and selected from the group comprising a fabric or laundry conditioning composition, a fabric or laundry detergent composition, and a laundry rinse additive composition; and
c. a container closure;
d. wherein the polymeric coating is derived from a polymer or polymer blend that crystalizes at a temperature of less than 100° C.; and
e. wherein the container closure comprises a polymeric material that crystalizes at a temperature of greater than 100° C.

20. The product of claim 19, wherein the polymeric coating comprises a polymeric material that has a glass transition temperature of below −50° C.; and wherein the container closure comprises a polymeric material that has a glass transition temperature of above −20° C.
